(19) United States
(12) Patent Application Publication
(10) Pub. No.: US 2017/0258177 A1
(43) Pub. Date: Sep. 14, 2017

(54) FLAME BLOCKING VENTING TRAP AND PROTECTION GARMENT THEREOF

(71) Applicant: CODET INC., Coaticook (CA)

(72) Inventor: Jean-Pierre AUDET, Coaticook (CA)

(21) Appl. No.: 15/599,459

(22) Filed: May 18, 2017

Related U.S. Application Data
(63) Continuation-in-part of application No. 14/096,808, filed on Dec. 4, 2013.
Application No. 14/096,808 is a continuation of application No. 14/691,008, filed on Apr. 20, 2015.
Application No. 14/691,008 is a continuation-in-part of application No. 14/096,808, filed on Dec. 4, 2013.
(60) Provisional application No. 61/875,738, filed on Sep. 10, 2013.
(60) Provisional application No. 61/875,738, filed on Sep. 10, 2013.

(30) Foreign Application Priority Data
Dec. 10, 2012 (CA) 2798649
Aug. 8, 2013 (CA) 2823035

(51) Int. Cl. A43B 7/34; A62B 17/00; A43B 7/08

(52) U.S. Cl. CPC A43B 7/34; A62B 17/003; A43B 7/085

(57) ABSTRACT

The application relates to a flame blocking venting trap (FBVT) adapted to vent a protection footwear, the FBVT comprising a proximal layer; a central venting layer superposed to the proximal layer; and a distal layer superposed to the central venting layer. The proximal layer is forming a first fold with the central venting layer and the central venting layer is forming a second fold with the distal layer to act as a flow restricting apparatus configured to prevent air and flames to get through the FBVT from the outside of the protection footwear and allow air to get through the FBVT from the inside of the protection footwear. A protection footwear including one or many FBVT is encompassed by the present application.

### CROSS-REFERENCES

The present application is a Continuation-In-Part and claims priority to U.S. patent application Ser. No. 14/096,808, filed Dec. 4, 2013, entitled FLAME BLOCKING VENTING TRAP AND PROTECTION GARMENT THEREOF, which is incorporated herein by reference, and which claims priority under 35 U.S.C. 119(e) to U.S. provisional patent application No. 61/875,738, filed Sep. 10, 2013, entitled FLAME BLOCKING VENTING TRAP AND PROTECTION GARMENT THEREOF, U.S. patent application Ser. No. 14/096,808, filed Dec. 4, 2013, entitled FLAME BLOCKING VENTING TRAP AND PROTECTION GARMENT THEREOF claims priority under 35 U.S.C. 119(a) to, Canadian patent application no. 2,798,649, filed Dec. 10, 2012, entitled COMBINAISON VENTILER, and to, Canadian patent application no. 2,823,035, filed Aug. 8, 2013, entitled TRAPPE D'AÉRATION IGNIFUGE, which are incorporated herein by reference in their entireties.

### BACKGROUND OF THE INVENTION

1. Field of the Invention

This invention generally relates to a flame blocking venting trap adapted to be installed on, or be incorporated in, a safety garment. The present invention more specifically relates to a flame blocking venting trap adapted to allow air venting while preventing flames to get through the protection garment and footwear and reach the skin of a wearer thereof.

2. Description of the Related Art

Protection garments have been used for many purposes against many environmental factors like oil, gas, grease dirt, solvent, chemicals, water and biohazard, among others. Workers performing tasks associated with significant fire hazards can also use them. For instance, they can be used in the gas and oil industries where the likelihood of fire blast, or flash fire, is present.

Protection garments can come in a variety of configurations. Shirts and pants can be used individually or collectively to protect a worker in accordance with the specifics of the tasks to accomplish. The protection garment can also be a one-piece article of clothing commonly called a coverall. A coverall is usually a loose fitting garment comprising a trouser-like portion and top portion, with or without sleeves, that is usually worn over casual clothing.

The material used in a protection garment is often rugged or intrinsically prevents air to pass therethrough because of its technical and protective properties. Venting in a protection garment has therefore a significant importance to prevent overheating of the wearer. Flexibility and comfort can also be challenging given the nature and the stiffness of the material.

It is therefore desirable to provide a flame blocking ventilation trap on a protection garment that allows ventilation therethrough while preventing flames to get through the ventilation trap.

It is desirable to provide an improved protection garment over the existing art that allows ventilation while preventing flames to get therethrough.

It is desirable to provide an improved ventilation trap over the existing art that can be easily assembled to the fabric of a safety garment and allows ventilation while preventing flames to get therethrough.

It is desirable to provide an improved ventilation trap over the existing art that has a reduced thickness and is easily assembled to the fabric without causing significant local rigidity to the safety garment.

It is desirable to provide an improved ventilation trap over the existing art that uses, in part, the same fabric as the material used in the safety garment and allows ventilation while preventing flames to get therethrough.

It is also desirable to provide an improved protection garment over the existing art that improves flexibility of the garment while allowing air circulation and prevents flames to pass through the garment and contact the skin of the wearer.

Other deficiencies will become apparent to one skilled in the art to which the invention pertains in view of the following summary and detailed description with its appended figures.

### SUMMARY OF THE INVENTION

One aspect of the present invention is to alleviate one or more of the shortcomings of the background art by addressing one or more of the existing needs in the art.

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention is generally described as a flame blocking ventilation trap and a garment including the flame blocking ventilation trap therein. For facilitating the reading of the application, flame blocking ventilation trap is going to be referred to below as “FBVT”.

Aspects of our work, in accordance with at least one embodiment, provide a FBVT that allows ventilation while preventing flames to get therethrough.

Aspects of our work, in accordance with at least one embodiment, provide a FBVT in a safety garment that allows ventilation of the garment while preventing flames to get therethrough.

Aspects of our work, in accordance with at least one embodiment, provide a FBVT that can be easily assembled to the fabric of a safety garment and allows ventilation while preventing flames to get therethrough.

Aspects of our work, in accordance with at least one embodiment, provide a FBVT that has a reduced thickness and is easily assembled to the garment without causing significant local increased rigidity of the safety garment.

Aspects of our work, in accordance with at least one embodiment, provide a FBVT that uses, in part, the same fabric as the material used for the safety garment and allows ventilation while preventing flames to get therethrough.

Aspects of our work, in accordance with at least one embodiment, provide a FBVT adapted to be restricted, or closed, when an external pressure is applied thereon and to open when the external pressure is removed.

Aspects of our work, in accordance with at least one embodiment, provide a FBVT having a “Z” shape adapted to route a flame blast from circulating through an opening in the FBVT.

Aspects of our work, in accordance with at least one embodiment, provide a FBVT having a double-fold “Z” shaped layout including a distal layer of material, a central layer of air permeable material (e.g. mesh) and a proximal layer of material adapted to route a flame blast from circulating through an opening in the FBVT.

Aspects of our work, in accordance with at least one embodiment, provide a FBVT configured to allow air ventilation of the garment while blocking flames to get through the garment.

Aspects of our work, in accordance with at least one embodiment, provide a FBVT configured to close an opening thereof when a flow of air reaches the FBVT from the exterior to prevent air to get through the garment through the FBVT.

Aspects of our work, in accordance with at least one embodiment, provide a garment comprising a FBVT therein.

Aspects of our work, in accordance with at least one embodiment, provide a FBVT including a mesh portion extending with a pair of non-mesh portions extending on respective sides of the mesh portion.

Aspects of our work, in accordance with at least one embodiment, provide a FBVT including a mesh portion extending with a non-mesh portions extending on a side of the mesh portion.

Aspects of our work, in accordance with at least one embodiment, provide a FBVT including a mesh portion extending with a non-mesh portions extending on a side of the mesh portion. Each non-mesh portion interconnecting a fabric portion via a fold.

Aspects of our work, in accordance with at least one embodiment, provide a FBVT including a first layer of fabric superposed over a layer of mesh portion, that is disposed over a second layer of fabric.

Aspects of our work, in accordance with at least one embodiment, provide a FBVT including, sequentially, a first layer of fabric, mesh portion, and a second layer of fabric.

Aspects of our work, in accordance with at least one embodiment, provide a FBVT including a mesh portion comprising a central mesh extended by at least one non-mesh portion.

Aspects of our work provide kit comprising a plurality of FBVTs adapted to be secured or sewed to a garment.

Aspects of our work provide a FBVT that complies with safety requirement NFPA 2112 and ASTM international requirement F1505.

Aspects of our work provide a flame blocking venting trap (FBVT) adapted to vent a garment, the FBVT comprising a proximal layer; a central venting layer superposed to the proximal layer; and a distal layer superposed to the central venting layer.

Aspects of our work provide a garment comprising a flame blocking venting trap (FBVT) adapted to vent the garment, the flame blocking coverall comprising a proximal layer; a central venting layer superposed to the proximal layer; and a distal layer superposed to the central venting layer.

Aspects of our work provide a flame blocking venting trap (FBVT) adapted to vent a garment and allow air to move out of a protective garment when the protective garment is heated.

Aspects of our work provide a flame blocking venting trap (FBVT) adapted to vent a garment and allow air to circulate inside the garment and move out of a protective garment when the protective garment is heated.

Aspects of our work provide a flame blocking venting trap (FBVT) adapted to vent a footwear.

Each of the embodiments of the present invention has at least one of the above-mentioned objects and/or aspects, but does not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

FIG. 1 is a schematic illustration of an FBVT in accordance with an embodiment of the invention;

FIG. 2 is a schematic illustration of an FBVT in accordance with an embodiment of the invention with air passing therethrough from the exterior of the garment;

FIG. 3 is a schematic illustration of an FBVT in accordance with an embodiment of the invention with air passing therethrough from the interior of the garment;

FIG. 4 is a schematic illustration of an FBVT in accordance with an embodiment of the invention with flame pattern thereof;

FIG. 5 is a schematic illustration of an FBVT in accordance with an embodiment of the invention with flame pattern thereof;

FIG. 6 is a schematic illustration of an FBVT in accordance with an embodiment of the invention with flame pattern thereof;

FIG. 7 is a schematic illustration of an FBVT in accordance with an embodiment of the invention with air flow pattern thereof;

FIG. 8 is a schematic illustration of an FBVT in accordance with an embodiment of the invention with air flow pattern thereof;

FIG. 9 is a schematic illustration of an exemplary mesh portion in accordance with an embodiment of the invention;

FIG. 10 is a schematic illustration of a front view of a coverall protection garment in accordance with an embodiment of the invention;

FIG. 11 is a schematic illustration of a rear view of a coverall protection garment in accordance with an embodiment of the invention;

FIG. 12 is a schematic illustration of a right-rear view of a protection garment in accordance with an embodiment of the invention;

FIG. 13 is a schematic illustration of a right-rear view of a protection garment in accordance with an embodiment of the invention;

FIG. 14 is a schematic illustration of a right-rear view of a protection garment in accordance with an embodiment of the invention;

FIG. 15 is a schematic illustration of a right-rear view of a protection garment in accordance with an embodiment of the invention;

FIG. 16 is a schematic illustration of a partial section view of a rear portion of a protection garment in accordance with an embodiment of the invention;

FIG. 17 is a schematic illustration of a rear portion of a protection garment in accordance with an embodiment of the invention with an airflow pattern thereof.

FIG. 18 is an illustration of a commercial embodiment of the present invention;

FIG. 19 is an illustrative flow chat of an exemplary process occurring when a safety garment is heated;

FIG. 20 is an illustrative flow chat of an exemplary process occurring when a safety garment is heated;

FIG. 21 is an illustrative flow chat of an exemplary process occurring when a safety garment is heated;

FIG. 22 is an illustration of a FBVT in accordance with at least one embodiment;

FIG. 23 is an illustration of a FBVT compressed by flames in accordance with at least one embodiment;

FIG. 24 is an illustration of a FBVT compressed by flames in accordance with at least one embodiment;

FIG. 25 is an illustration of a FBVT applied to a footwear in accordance with at least one embodiment;

FIG. 26 is an illustration of a FBVT applied to a footwear in accordance with at least one embodiment; and

FIG. 27 is an illustration of a FBVT applied to a footwear in accordance with at least one embodiment.

### DESCRIPTION OF EMBODIMENT(S) OF THE INVENTION

Our work is now described with reference to the figures. In the following description, for purposes of explanation, numerous specific details are set forth in order to provide a thorough understanding of the present invention by way of embodiment(s). It may be evident, however, that the present invention may be practiced without these specific details.

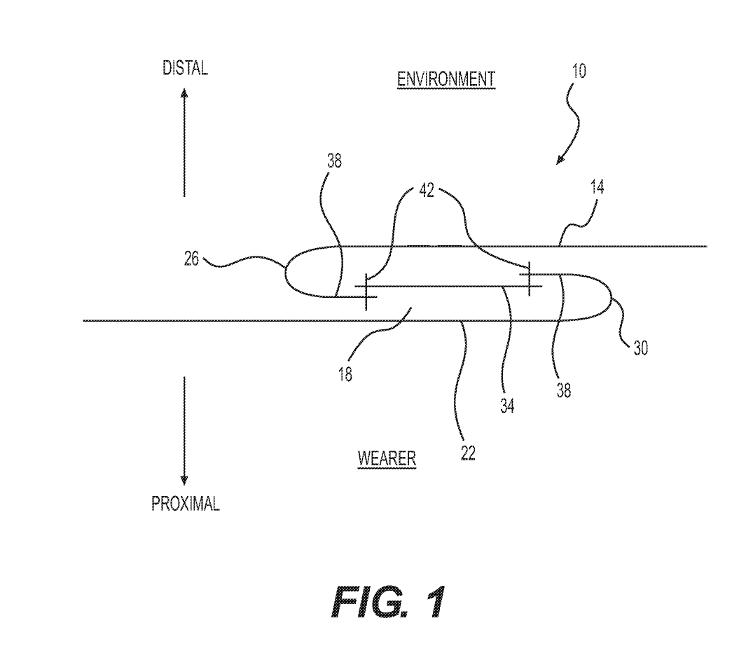

A schematic FBVT 10 is illustrated in FIG. 1 in accordance with an embodiment of the invention. The FBVT 10 comprises a distal fabric layer 14, a central venting layer 18 and a proximal fabric layer 22. The distal fabric layer 14 is interconnected with the central venting layer 18 with an intervening external curve, or fold 26, and the central venting layer 18 is interconnecting the proximal fabric layer 22 with an intervening internal curve, or fold 30. The central venting layer 18 further includes a mesh portion 34 and extension fabric portions 38. The central venting layer 18 can be made of a single part including a portion adapted to allow an air passage thereof and can alternatively be made of an assembly of different types of fabrics and mesh. FIG. 1 illustrates an assembled central venting layer 18 where different materials 34, 38 are secured with stitches 42 or any other means adapted to secure materials together with sufficient strength (e.g. Velcro™, glue, . . . ).

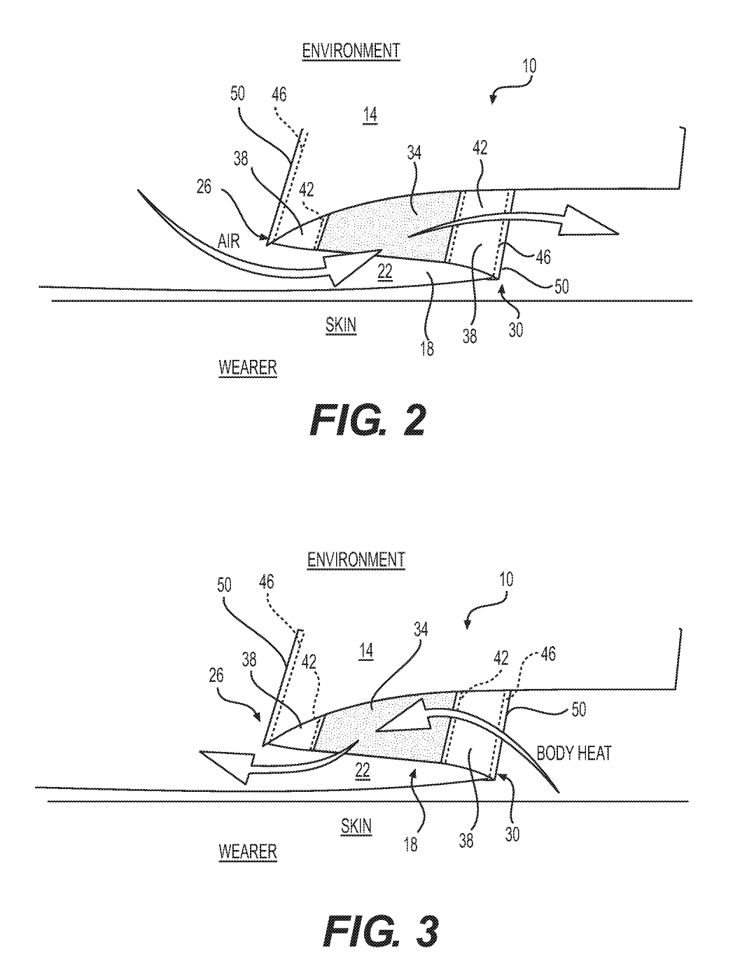

A typical flow of air through the FBVT 10 is illustrated in FIG. 2. The flow of air is channeled from the environment between the central venting layer 18 and the proximal fabric layer 22 to pass through the mesh portion 22 and continue between the central venting layer 18 and the distal fabric layer 14 to reach the interior side of the FBVT 10 to vent the wearer of the safety garment. FIG. 3 illustrates the opposite body heat transfer from the interior side of the FBVT 10 to the environment under normal circumstances. One can also appreciate that the FBVT 10 has sort of a “Z” shape (or “S” shape) with well-defined folds 26, 30 thereof to produce a path of fabric adapted to channel air thereof. A flow of air from the inside of the garment tends to open the FBVT. The FBVT, in the present embodiment, includes additional seams 46 next to the edges 50 of the FBVT 10 to form folds. Well-defined folds 36, 30 could alternatively be made by pressing or gluing, thermo-forming the material in the desired shape. Other means to form the material can become apparent to a skilled reader and remain within the scope of the present invention.

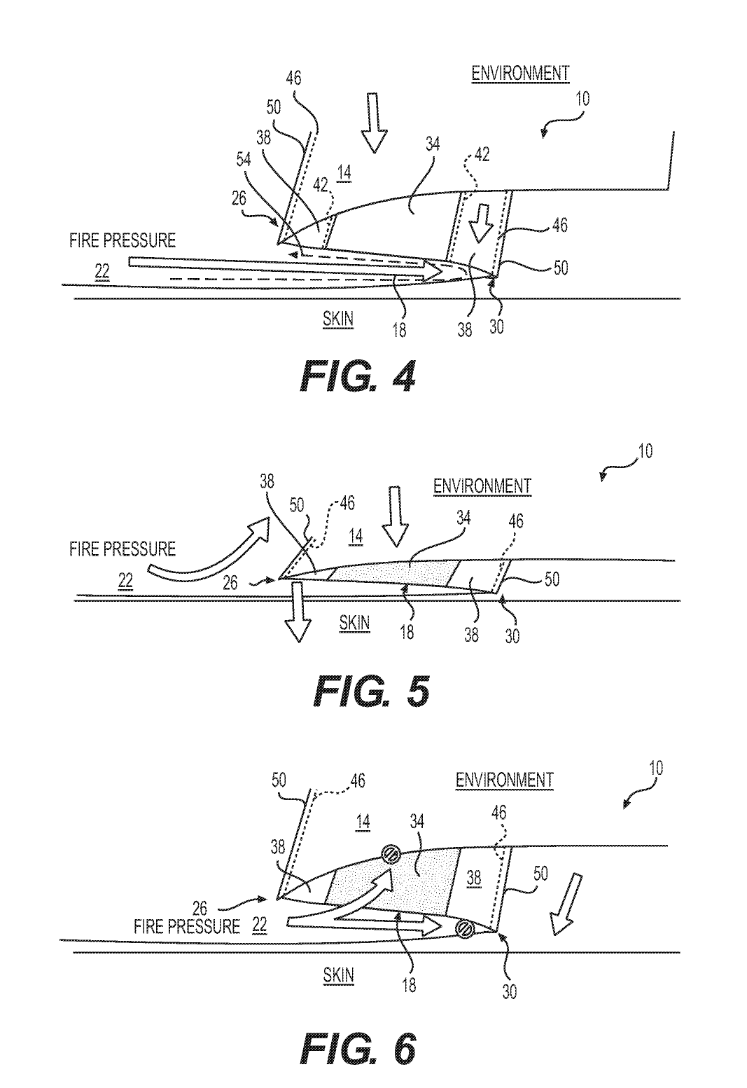

The FBVT 10 acts differently when a flame blast reaches the FBVT 10 from the environment. FIG. 4 illustrates that the FBVT 10 protects from flames hitting the FBVT 10 from the environment by compressing the layers 14, 18, 22 of the FBVT 10 that, in turn, is going to close the FBVT 10 as illustrated in FIG. 5 and thus prevent the flames to get through the FBVT 10 with the fire pressure. A flow of air from the outside of the garment 66 thus tends to close the FBVT. The FBVT 10 can also reacts differently if the flame blast comes parallel with the layer 22. The extension fabric portion 38 next to the internal edge 50 prevents the flame to be directed through the mesh portion 34 and redirects the flame in the opposite direction 54. The configuration of the FBVT 10 also prevents any direct contact with the skin of a wearer as illustrated in FIG. 6. One can appreciate from FIG. 6 that a flame would pass through the mesh portion 34 to hit the distal fabric layer 14 or be confined in the internal fold 50 thus providing an additional safety protection should a flame reaches the mesh portion 34.

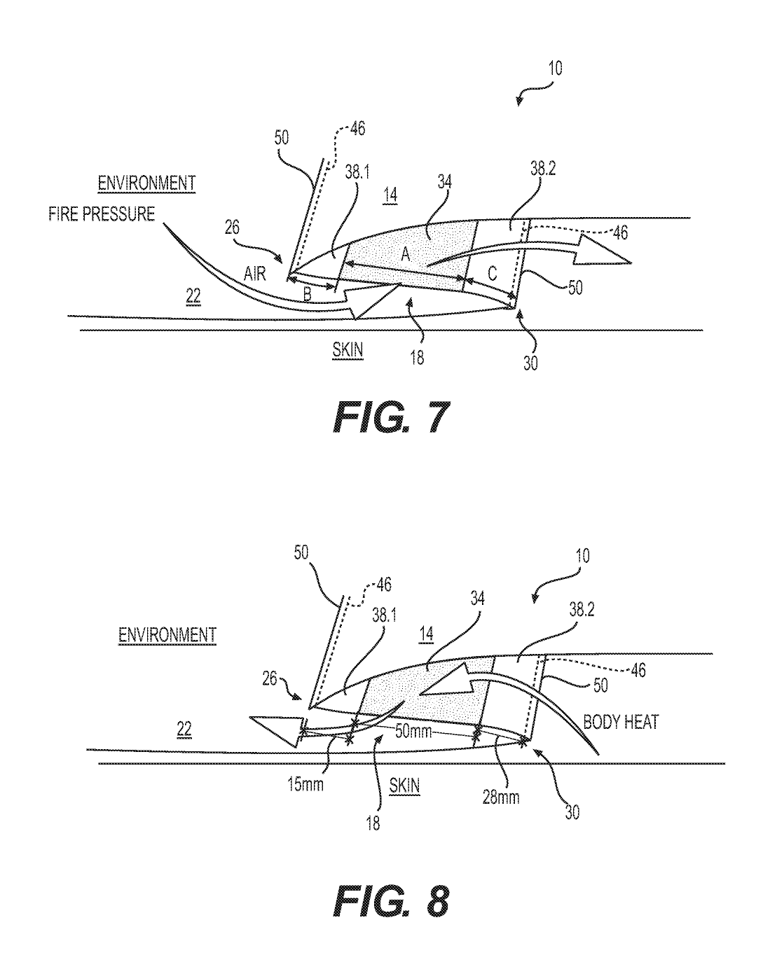

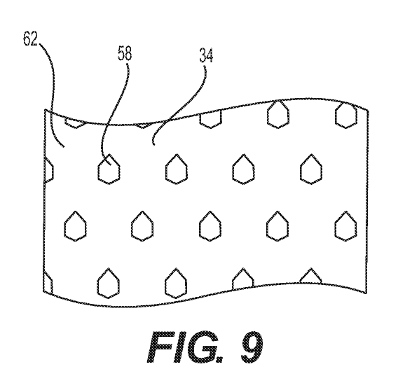

FIG. 7 depicts embodiment of lengths ratios of mesh portion 34 in respect with extension fabric portions 38.1, 38.2. In an embodiment, the length A of the mesh portion 34 can vary between 10 mm and 100 mm, the length B of the extension fabric portion 38.1 can vary between 0 mm and 50 mm and finally the length C of extension fabric portions 38.2 can vary between 0 mm and 50 mm. Preferably, the length A of the mesh portion 34 can vary between 25 mm and 75 mm, the length B of the extension fabric portion 38.1 can vary between 0 mm and 30 mm and finally the length C of extension fabric portions 38.2 can vary between 10 mm and 40 mm. More preferably, the length A of the mesh portion 34 can vary between 40 mm and 60 mm, the length B of the extension fabric portion 38.1 can vary between 10 mm and 25 mm and finally the length C of extension fabric portions 38.2 can preferably vary between 20 mm and 35 mm. Other lengths can also be used depending of the design of the garment and the specific venting requirement. The lengths ratios can change depending of the size and design of the FBVT 10 and can be about (0@1)B for (2@5)A for (0@3)C, preferably about (0@1)B for (3@5)A for (1@3)C, and more preferably about (1)B for (4)A for (2)C (1B:4A:2C). FIG. 9 depicts an embodiment with more precise lengths to illustrate one of the preferred embodiments.

Turning now to FIG. 9 illustrating an exemplary mesh portion 34 in accordance with an embodiment of the invention. The mesh portion 34 is provided with a series of holes or openings 58 adapted to let air pass therethrough. The remaining portion of the mesh portion 34 is fabric material 62 adapted to provide mechanical strength to the mesh portion 34.

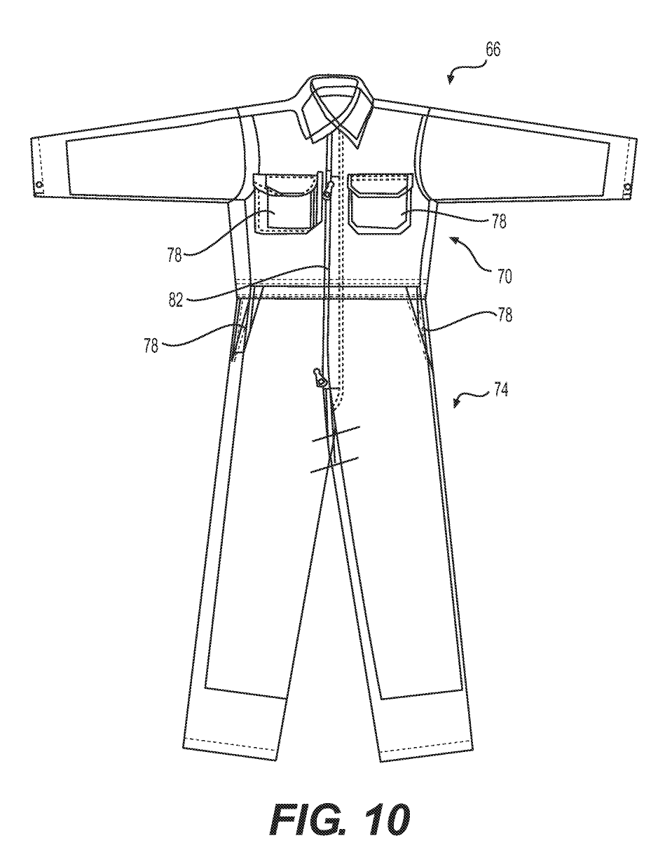

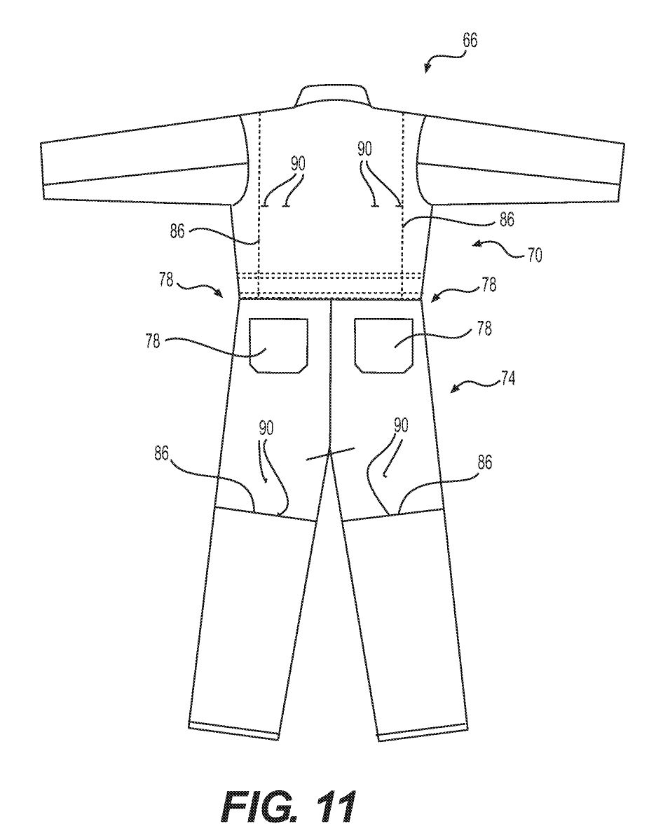

A protection garment 66 is schematically illustrated in FIG. 10 in a front view. The protection garment 66 includes an upper portion 70 and a lower portion 74 that can be used independently or collectively. An assembled upper portion 70 and lower portion 74 can be called a one-piece coverall. The illustrated protection garment 66 includes pockets 78 and a zipper 82, or a securing means, to secure the protection garment on a wearer. FIG. 11 is a back view of the protection garment 66 of FIG. 10. One can appreciate from FIG. 11 possible venting zones 86 on the protection garment 66 where a FBVT 10 can be located. FBVT 10 can be disposed vertically and horizontally on the protection garment 66. The FBVT 10 can be located in the region of an articulation to help open the FBVT 10 with the movements of a wearer. One can appreciate that restrictors 90 are located between the distal layer 14 and the proximal layer 22 to secure the three layers 14, 18, 22 together and set a maximum opening of the FBVT 10 thus preventing excessive opening of the FBVT 10. The number, the location and the size of the restrictors 90 can vary while remaining within the scope of the invention.

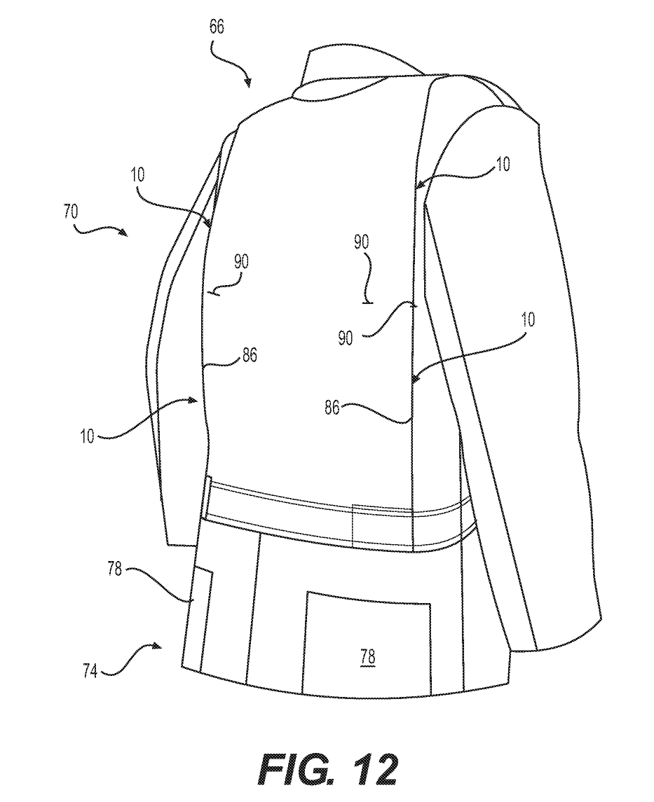

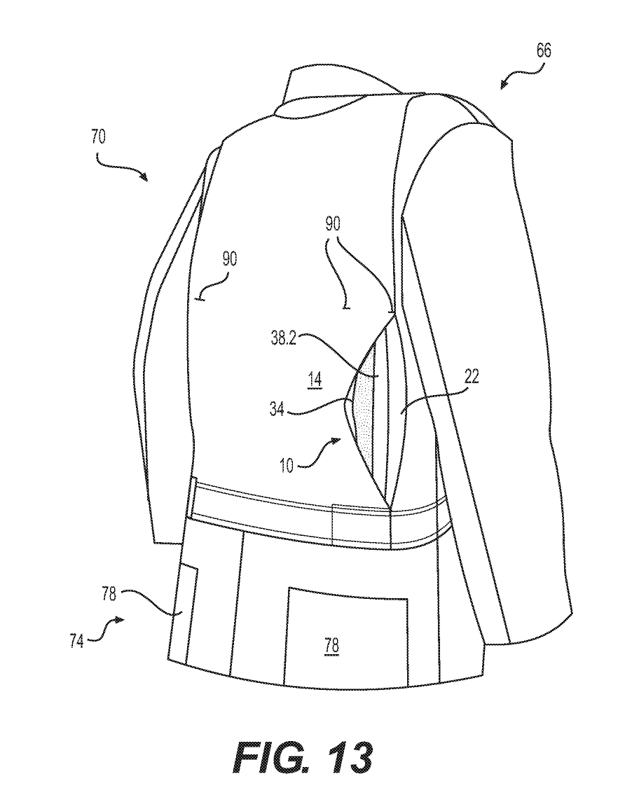

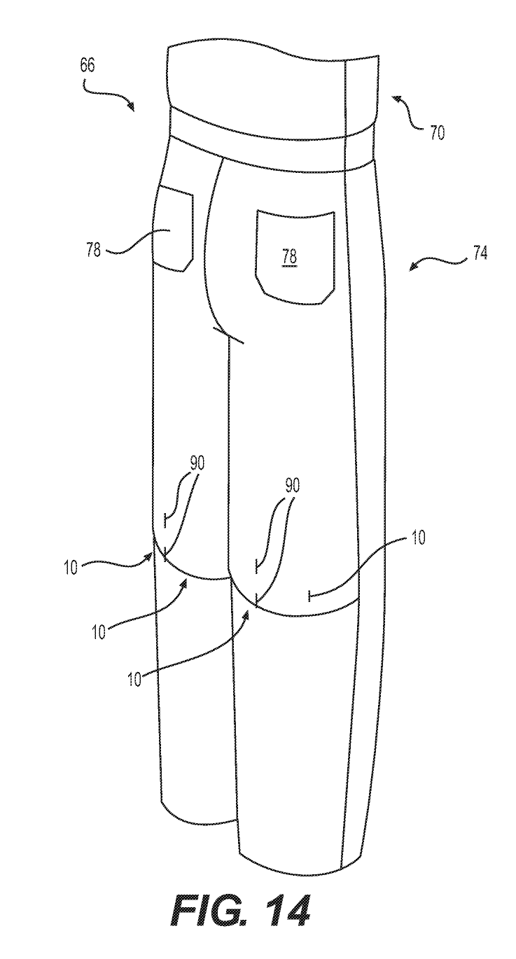

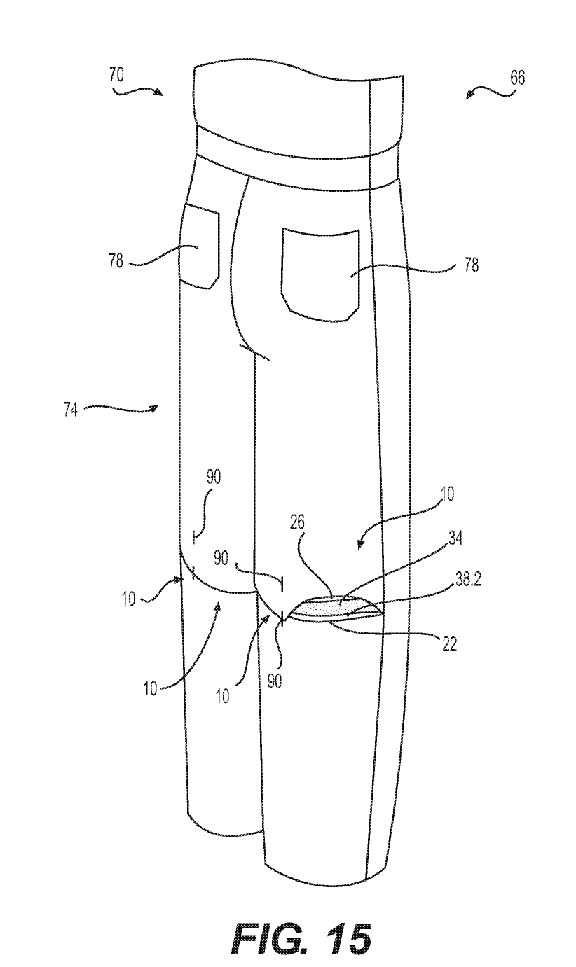

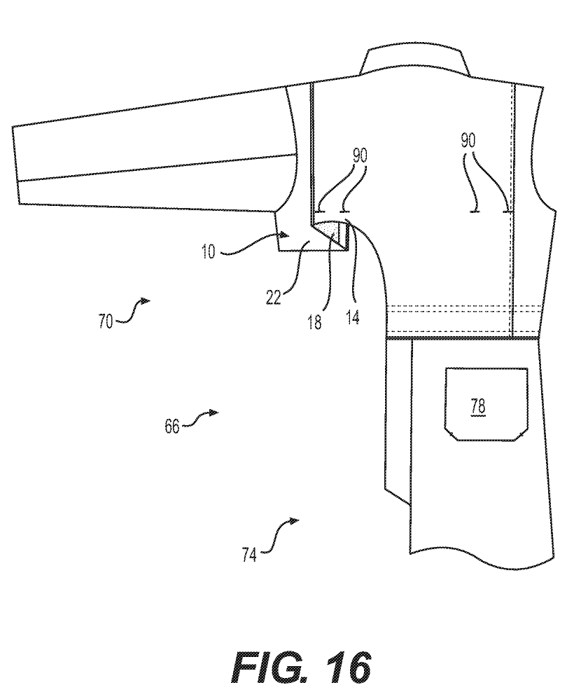

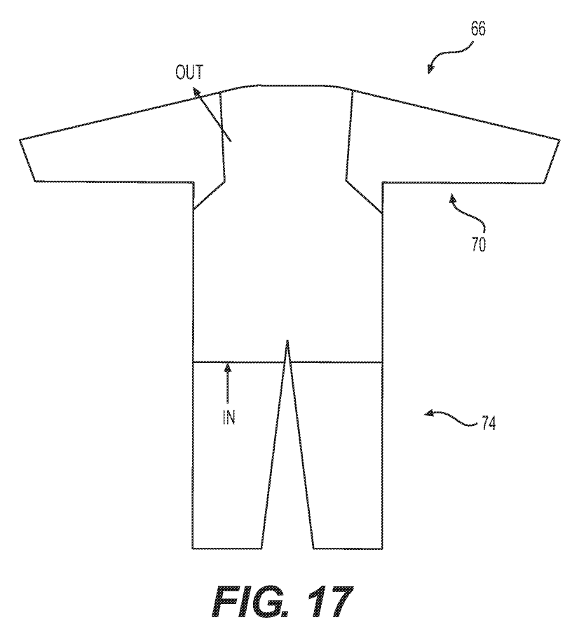

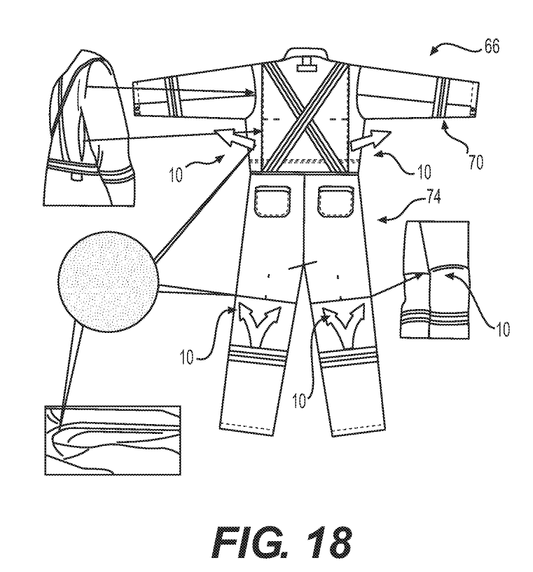

A FBVT 10 is located on the upper portion 70 of the protection garment 66 in a closed position, as seen in FIG. 12, and in an open position as seen in FIG. 13. A FBVT 10 is located on the lower portion 74 of the protection garment 66, behind the knee and is depicted in a closed position in FIG. 14 and in an open position in FIG. 15. A long FBVT 10 is illustrated and its opening is controlled by its associated restrictor 90. Two or more shorter FBVT 10 could alternatively be used instead of a long FBVT 10 without departing from the scope of the invention. FIG. 16 illustrates a sectional view of a FBVT 10 on the upper portion 70 of the safety garment 66 to appreciate its configuration in more details. FIG. 17 depicts a cooling flow of air between two FBVT 10 in accordance with another embodiment of the invention using collectively a plurality of FBVT 10 to vent a protection garment 66. And finally, FIG. 18 provides another view of a convecting coverall 70 equipped with a plurality of FBVT 10 in accordance with an embodiment of the invention.

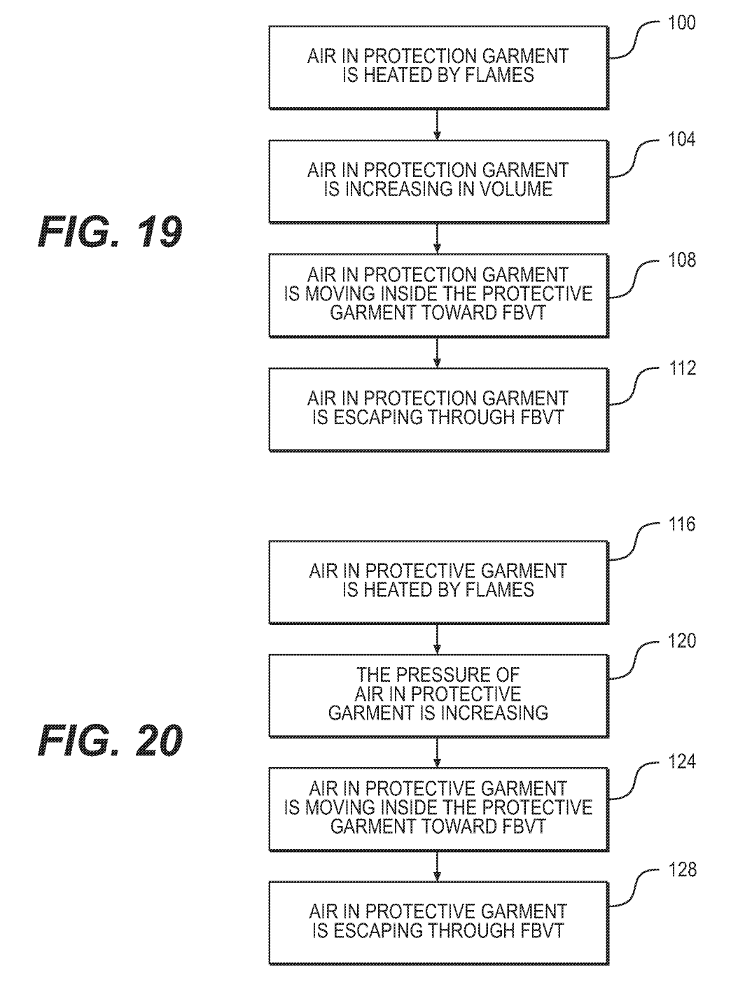

Moving now to FIG. 19 illustrating an exemplary flow chart in accordance with an embodiment of the invention. A volume of air is present in a protection garment 66. This volume of air is surrounding a wearer of the protection garment 66. The volume of air in the protection garment 66 increases in volume 104 when heated by flames 100 contacting the protection garment 66 in a flash fire situation. The increasing volume of air inside the protection garment 66 is moving 108 inside the protection garment 66 and seeks to escape to the exterior of the protection garment 66, 112 through the FBVT 10 of the protection garment 66. The movement of the heated air trapped in the FBVT 10 is providing a moving layer of air in the protection garment 66 between the fabric of the protection garment 66 and the body of the wearer of the protection garment 66. Locations where the fabric of the protection garment 66 is in contact with the body of the wearer can be distanced by the moving air inside the protection garment 66 and further protect the wearer. The air moves along to find its way to the FBVT 10 and exits the protection garment 66. The air exiting the protection garment 66 can influence the flames outside the protection garment 66 by providing an additional protective layer of air outside the protection garment 66.

An analogous phenomenon is depicted in FIG. 20 illustrating another exemplary flow chart in accordance with an embodiment of the invention. A volume of air inside the protection garment 66 is surrounding the wearer of the protection garment 66. The volume of air in the protection garment 66 increases in pressure 120 when heated by flames 116 contacting the protection garment 66 in a flash fire situation. The increasing pressure of air inside the protection garment 66 is moving 124 inside the protection garment 66 and seeks to escape to the exterior of the protection garment 66, 128 through the FBVT 10 of the protection garment 66. The movement of the increased air pressure trapped in the FBVT 10 is providing a moving layer of air in the protection garment 66 between the fabric of the protection garment 66 and the body of the wearer of the protection garment 66. Locations where the fabric of the protection garment 66 is in contact with the body of the wearer can be distanced by the moving air inside the protection garment 66 and further protect the wearer. The air moves along to find its way to the FBVT 10 and exits the protection garment 66. The air exiting the protection garment 66 can influence the flames outside the protection garment 66 by providing an additional protective layer of air outside the protection garment 66.

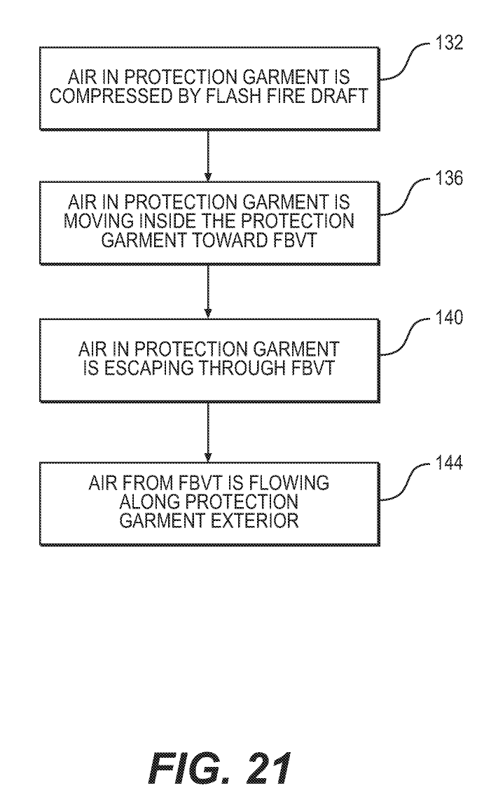

Another analogous phenomenon is depicted in FIG. 21 illustrating another exemplary flow chart in accordance with an embodiment of the invention. A volume of air inside the protection garment 66 is surrounding the wearer of the protection garment 66. The volume of air in the protection garment 66 is compressed 132 when heated by flames contacting the protection garment 66 in a flash fire situation. The increasing pressure of air inside the protection garment 66 is moving the air 136 inside the protection garment 66 and seeks to escape to the exterior of the protection garment 66, 140 through the FBVT 10 of the protection garment 66. The movement of the compressed air trapped in the FBVT 10 is providing a moving layer of air in the protection garment 66 between the fabric of the protection garment 66 and the body of the wearer of the protection garment 66. Locations where the fabric of the protection garment 66 is in contact with the body of the wearer can be distanced by the moving air inside the protection garment 66 and further protect the wearer. The air moves along to find its way to the FBVT 10 and exits the protection garment 66. The air exiting the protection garment 66 and flowing along the protection garment exterior 144 can influence the flames outside the protection garment 66 by providing an additional protective layer of air outside the protection garment 66.

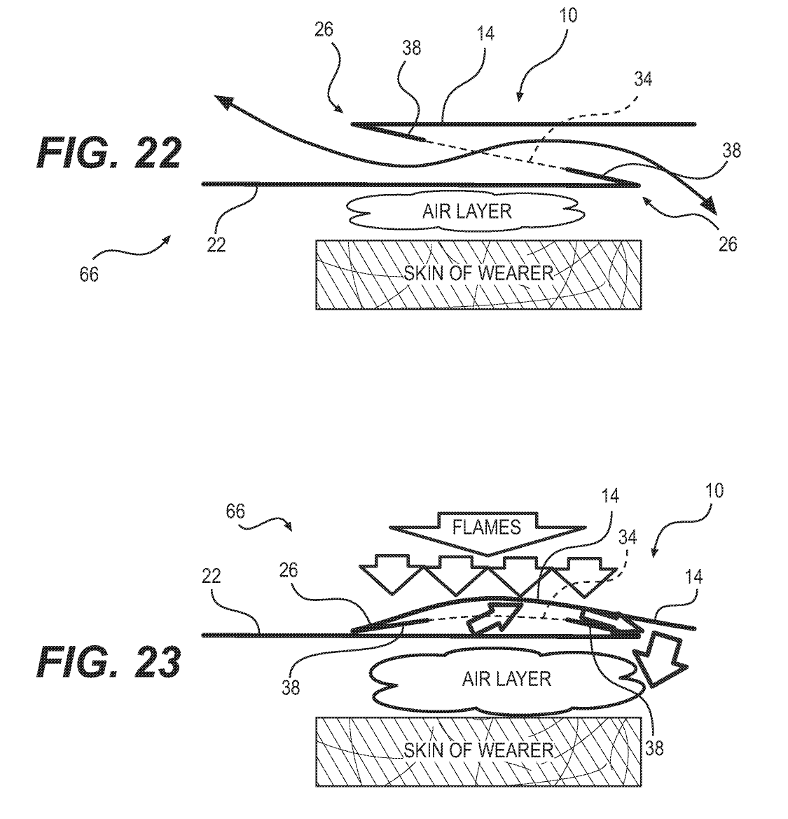

FIG. 22 depicts free flow of air through the FBVT 10. The FBVT 10 can react by compressing the distal fabric layer 14 toward the proximal fabric layer 22 under a flash fire as illustrated in FIG. 23. The compressed FBVT 10 propels the air trapped thererein inside the protection garment 66 hence increasing the layer of air inside the protection garment 66. The increased volume of air inside the protection garment 66 is providing added protection to the wearer of the protection garment 66.

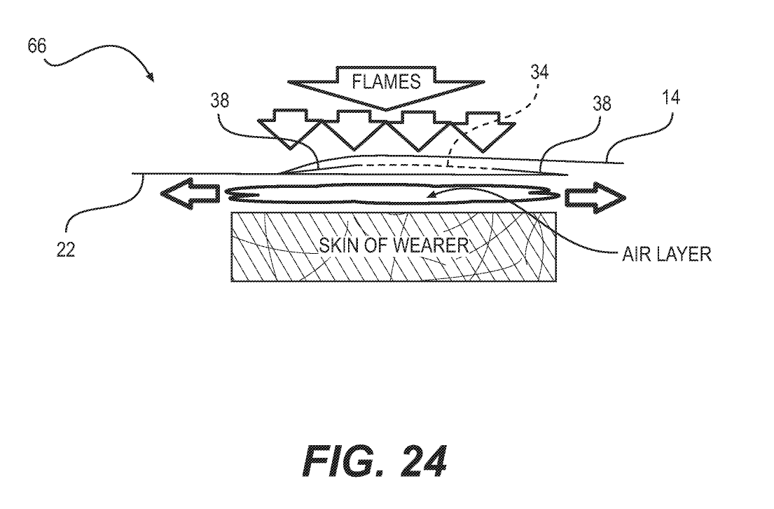

Another behavior of the FBVT 10 in accordance with another embodiment is illustrated in FIG. 24. The flames are applying pressure on the FBVT 10 and the air trapped in the protection garment 66 is circulating between the protection garment 66 and the wearer. The moving air in the protection garment 66 is helping preventing direct contact between the protection garment 66 and the wearer.

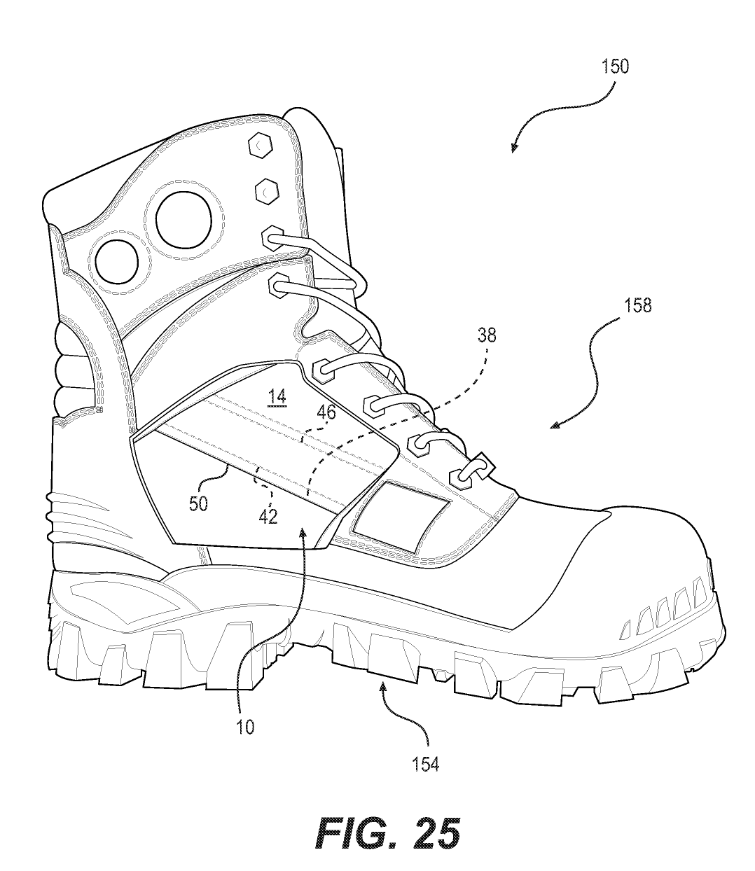

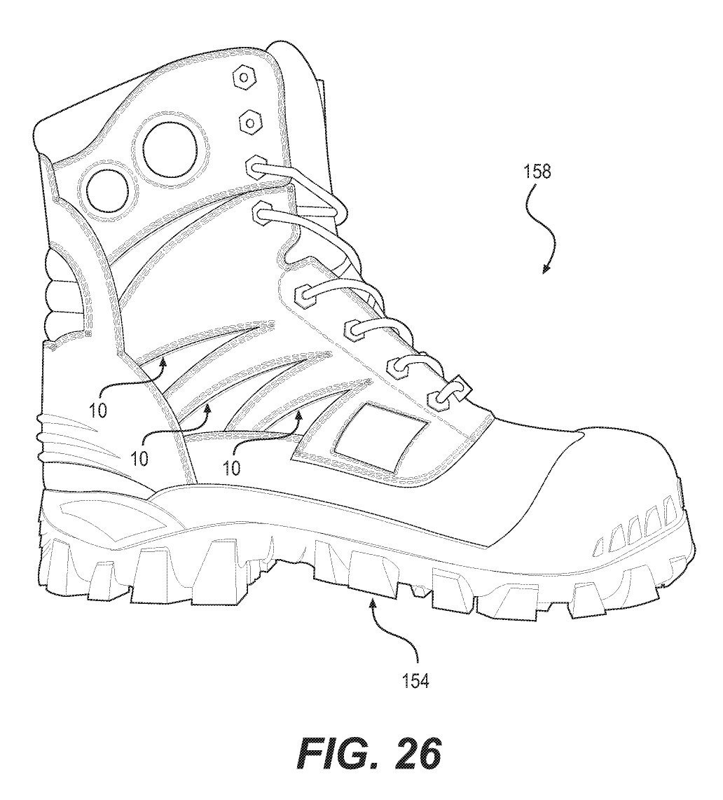

The FBVT 10 of the present invention can be embodied in a protection footwear 150 as it can be appreciated in FIG. 25. The FBVT 10 on the protection footwear 150 is illustratively disposed on a distal side 154 of the protection footwear 150. The FBVT 10 could be positioned elsewhere on the protection footwear 150 in locations where the structure and the functions of the protection footwear 150 are not going to be jeopardized. In the present situation, a single FBVT 10 is disposed on the distal side of the protection footwear 10. Alternatively, a corresponding FBVT 10 could be provided on the proximal side 158 of the protection forward 150. FIG. 26 illustrates another possible embodiment including a plurality of FBVT 10 on the distal side of the protection footwear 10. Another possible unillustrated embodiment could include a plurality of FBVT 10 on the proximal side of the protection footwear 10.

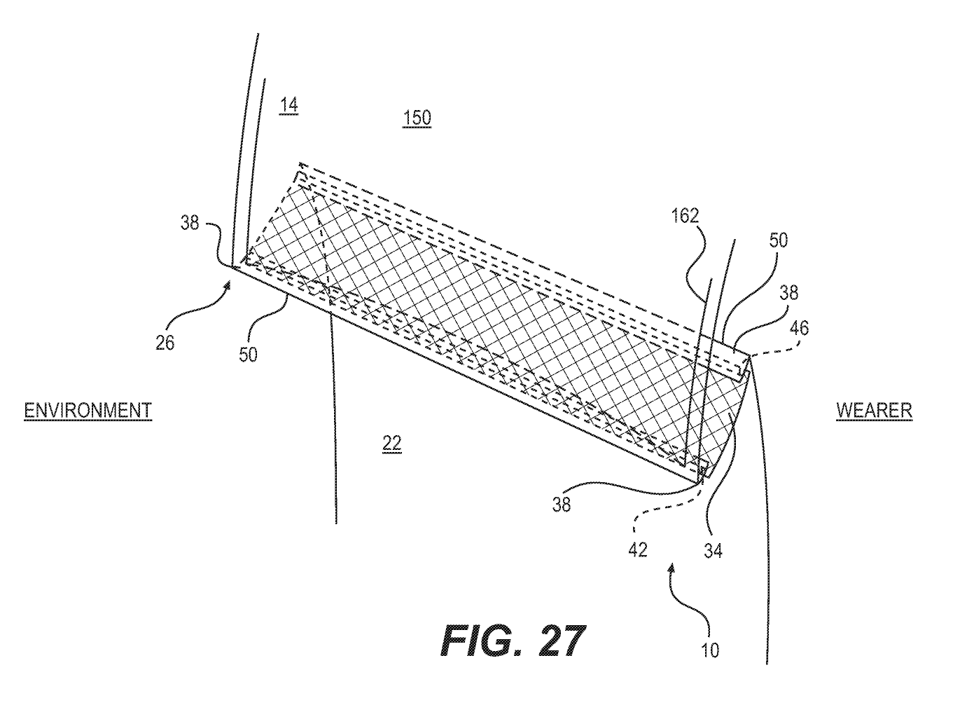

A magnified portion of the protection footwear 150 is depicted in FIG. 27. One can appreciate the FBVT 10 comprises a distal fabric layer 14, a central venting layer 18 and a proximal fabric layer 22. The distal fabric layer 14 is interconnected with the central venting layer 18 with an intervening external fold 26, and the central venting layer 18 is interconnecting the proximal fabric layer 22 with an intervening internal fold 30. The central venting layer 18 further includes a mesh portion 34 and extension fabric portions 38. The central venting layer 18 can be made of a single part including a portion adapted to allow an air passage thereof and can alternatively be made of an assembly of different types of fabrics and mesh. A forming member 162 can optionally be added in the FBVT 10 to bias an opening in the FBVT 10 when the FBVT 10 is constructed with thick materials as generally used in protection footwears 66. The forming member 162 can be an added part. The forming member 162 can alternatively be a fabric treatment adapted to shape the fabric used in the FBVT 10. The forming member 162 is designed in such a way that the opening through the FBVT 10 can be actuated to block flash fires as explained above.

The description and the drawings that are presented above are meant to be illustrative of the present invention. They are not meant to be limiting of the scope of the present invention. Modifications to the embodiments described may be made without departing from the present invention, the scope of which is defined by the following claims:

1-20. (canceled)

21. A fabric vent, comprising:
(a) a proximal fabric layer;
(b) a central venting layer connected to the proximal fabric layer by an internal fold such that the central venting layer extends over the proximal fabric layer; and
(c) a distal fabric layer connected to the central venting layer by an external fold such that the distal fabric layer extends over the central venting layer;
(d) wherein the central venting layer comprises
(i) a mesh portion that is made from a first material, that is configured to allow a flow of air to pass therethrough, and that is located between the external fold and the internal fold, and
(ii) an internal extension fabric portion that is made from a second material that is different from the first material, and that extends from the mesh portion to the internal fold.

22. The fabric vent of claim 21, further comprising means for securing together the mesh portion and the internal extension fabric portion.

23. The fabric vent of claim 21, wherein the central venting layer further comprises an external extension fabric portion, the external extension fabric portion extending from the mesh portion to the external fold.

24. The fabric vent of claim 23, further comprising means for securing together the mesh portion and the internal extension fabric portion; and further comprising means for securing together the mesh portion and the external extension fabric portion.

25. The fabric vent of claim 21, wherein the mesh portion of the central venting layer comprises a fabric material having a series of holes formed therein that are adapted to let air pass therethrough for venting of the garment.

26. The fabric vent of claim 25, wherein the second material of the internal extension fabric portion is a non-mesh material.

27. The fabric vent of claim 21, wherein the vent is configured to block fire from getting through the vent when the proximal fabric layer, the distal fabric layer, and the central venting layer are compressed together.

28. The fabric vent of claim 27, wherein the layers of the vent form a “S” or “Z” shaped cross-sectional configuration.

29. The fabric vent of claim 21, wherein the mesh portion extends a length of between 25 mm and 75 mm in a direction from the external fold toward the internal fold toward, and wherein the internal extension fabric portion extends a length of between 10 mm and 40 mm from the mesh portion to the internal fold.

30. The fabric vent of claim 21, wherein the internal fold and the external fold each has a defined fold shape.

31. The fabric vent of claim 30, wherein the defined fold shape comprises a pressed fabric fold.

32. The fabric vent of claim 30, wherein the defined fold shape comprises a glued fabric fold.

33. The fabric vent of claim 30, wherein the defined fold shape comprises a stitched fabric fold.

34. The fabric vent of claim 21, wherein the fabric of the proximal fabric layer and the fabric of the distal fabric layer comprise the same fabric.

35. The fabric vent of claim 34, wherein the fabric of the internal extension fabric layer comprises the same fabric as the fabric of the proximal fabric layer and the fabric of the distal fabric layer.

36. The fabric vent of claim 35, wherein the internal fold comprises a fabric fold having a defined shape.

37. The fabric vent of claim 36, wherein the fabric of the internal fold comprises the same fabric as the fabric of both the internal extension fabric layer and the fabric of the proximal fabric layer.

38. A fabric vent, comprising:
(a) a proximal fabric layer;
(b) a central venting layer connected to the proximal fabric layer by an internal fold such that the central venting layer extends over the proximal fabric layer; and
(c) a distal fabric layer connected to the central venting layer by an external fold such that the distal fabric layer extends over the central venting layer;
(d) wherein the central venting layer comprises a mesh portion that is configured to allow a flow of air to pass therethrough, and that is located between the external fold and the internal fold; and
(e) further comprising means for preventing a flame from passing through the vent into an interior of the garment when an external fire pressure is applied to the vent.

39. The fabric vent of claim 38, wherein the means comprises a non-mesh material that extends from the mesh portion to the internal fold.

40. Footwear having a vent, the vent comprising:
(a) a proximal fabric layer;
(b) a central venting layer connected to the proximal fabric layer by an internal fold such that the central venting layer extends over the proximal fabric layer; and
(c) a distal fabric layer connected to the central venting layer by an external fold such that the distal fabric layer extends over the central venting layer;
(d) wherein the central venting layer comprises
(i) a mesh portion that is made from a first material, that is configured to allow a flow of air to pass therethrough, and that is located between the external fold and the internal fold, and
(ii) an internal extension fabric portion that is made from a second material that is different from the first material, and that extends from the mesh portion to the internal fold.
